(19) United States
(12) Patent Application Publication
(10) Pub. No.: US 2015/0123451 A1
(43) Pub. Date: May 7, 2015

(54) Drive System

(71) Applicant: David W. Nelson, Canton, NC (US)

(72) Inventor: David W. Nelson, Canton, NC (US)

(21) Appl. No.: 14/071,539

(22) Filed: Nov. 4, 2013

(51) Int. Cl. B60B 19/00; B60B 19/14

(52) U.S. Cl. CPC B60B 19/003; B60B 19/14
USPC 301/6.5

(57) ABSTRACT

An engine is describes that includes a plurality of rotating wheels, each of the wheels having weights contained therein and the weight result in an unbalance condition. Two inner wheels, rotate at the same speed and in opposite directions within an outer wheel that that also is rotating and the rotation of the weights creates a force vector orbit that is in the shape of a bridged figure eight. The disclosure includes a embodiments that involve the movement of weights on the wheels to alter the profile of the orbit.

### BACKGROUND OF THE INVENTION

The Applicant claims the benefit of the filing date of U.S. Application No. 61,796,094 tiled on Nov. 2, 2013. The present invention relates to a drive system using a plurality of weighted spinning wheels or arms that create momentum using a bridged figure eight shaped orbit that is the effect of two rotational cycles, an outer cycle and an inner cycle. The outer cycle turns the inner cycle in a sideways rotation, 90 degrees from its own rotational axis. When a weighted object is added to the combination on the inner cycle a first orbit is created. The orbit is affected by both cycles and their rotating directions and timing and generally creates a bridged figure-eight shaped orbit. Adding the moment of inertia to the weighted object in the defined orbit, a non-countered inertia three is created at the two top quarters of one cycle. When vertical and horizontal rotational maneuverability is added to the position that the inertia force is directed, a driving force is created along a vector.

A first embodiment of the invention is therefore directed to a drive engine, wherein using electric motors, it creates a directional drive system contained within a spherical-shaped device referred to as “wheel works” or wheel element assembly. The device has an advantageous thrust to weight package, and, by working them in symmetrical arrangements they can be used for omni-directional maneuvers of a vehicle. In embodiments, the engine is driven using electricity and therefore can be adapted to navigating in a variety of environments and terrains.

### SUMMARY OF THE INVENTION AND DESCRIPTION OF EMBODIMENTS THEREOF

The present invention is directed to a rotating first wheel or wheels within a third rotating wheel that is oriented on an axis 90 degrees from the first wheel. The device operates like a conventional gyroscope but in embodiments a second wheel is provided that spins in the opposite direction of the first wheel thereby neutralizing gyro effects. In preferred embodiments, the wheels are constructed from strong, lightweight materials, such as aluminum, synthetic resins, fiberglass and composites using carbon fiber. In a preferred embodiments, two center, closely sandwiched inner wheels are a provided that share a common rotational axis. These wheels are positioned within a third wheel or annulus and a line defining the diameter of the first wheels is oriented at a right angle or perpendicular to the plane defined by the outer wheel. The dimensions of the inner wheels are such that they will fit within the inner rim of the outer wheel or annulus.

As discussed above, in preferred embodiments the inner wheels are both simultaneously driven in opposite directions by magnetic propulsion. In this regard, a dynamic magnetic field generated from electromagnets is positioned at locations adjacent to the outer rim of the respective inner wheels and at a position 90 degrees from the axis formed by the outer wheel. The inner wheels and outer wheel are rotated at the same constant speed and therefore having synchronized timing of 1:1 ratio. The two inner wheels have rims that each in turn have weights positioned near the periphery with no counter balance. The wheels are mechanically connected so that when the inner wheels axe rotated the weights will be positioned directly opposite one another at two moments in each rotational cycle. As the outer wheel turns at a 1:1 ratio with the inner wheels rotations, the timing of the inner wheels passing of the weights at the bottom cycle accrues when the bottom has been rotated by the outer wheel into the said top position. As discussed below, the rotational cycles or the inner and outer wheels will have two top positions of weights passing in one cycle and two opposing occurrences at the left and right sides. The resulting orbits of the weights in the wheels result in a bridged figure eight orbit configuration. When all rotations are started and the speed is increased the weights transition to a vector force, sustained as long as the rotations are sustained. The force is applied at two top positions of one cycle, thereby creating two moments of force without counter balance force. As a result there is a directional or vector force that is created from the cyclic rotation.

In embodiments, the rims of the outer wheels left and right sides may be extended with half domes thereby creating an outer spherical shell or globe-shaped wheel. Preferably this globe-shaped wheel is made from a light-weight, shock resistant structural material. It is contemplated that the shell or dome may be comprised of Lexan® or other transparent thermoplastic resin composite materials. In alternative embodiments, the outer wheel includes a layer of vulcanized rubber. The globe-shaped outer wheel completely encloses the inner wheels, and serves as a means to reduce air turbulence and motion acting on the wheels. In embodiments, a vacuum may be applied to reduce air pressure or the interior of the globe may be provided with a lighter than air gas such as helium.

The globe wheel has a means of support located on opposite sides which form a lateral axel. The spokes of the inner wheels include powerful magnet rods with their polarities aligned in the same outward-feeing direction around the wheel.

The globe-shaped wheel has two types of spokes. A series of center spokes are connected to the inner wheels axis shaft and to me rim of the outer wheel. These center spokes comprise magnetic rods. A second type of spokes are thin bicycle wheel like spokes, referred to as globe spokes, that extend from the inner axis shaft to locations on the interior surface of the extended shell sections of the outer wheel. These globe spokes attach within each of the globe wheel's two half dome parts. These globe spokes are attached at a plurality of locations, and include a support means for stabilizing stresses from the inset wheels axis shaft with the outer globe wheel [should explain] The thin globe spokes are attached to the globe section using a washer that includes a curve surface that conforms to the inner surface of the globe and a threaded nut. This attachment arrangement reduces the spoke attachment stress points on the globes when the spokes are connected. The inner wheels are provided with a thin flat disk to support roller bearing gears, separating and supporting the said two inner wheels. The flat disks gear roller bearings support one of the inner wheels against the other inner wheel and have a roller bearing part and a toothed gear portion centered on the roller. As such these roller bearings enable the inner wheels to maintain a fixed position to one another during rotation.

The rotation of the outer wheel which when powered by magnetic pulses is accomplished using magnetic sensors which send a signal to a processor. The sensors send signals to the processor which in turn activate or deactivate the electromagnetic elements positioned at the periphery of the wheels to increase or decrease the electromagnetic force delivered to the inner and outer wheel magnets. The permanent magnetic rods located in the wheel spokes exert a pulling force towards a first switch position of the electromagnet's iron core and, at top center alignment position between the magnetic rod and me driving magnets a second switch position. This arrangement enables a high powered electromagnetic pulse to be generated which will attract and then repel the magnetic rods causing the wheel to rotate away.

The entire wheel works assembly is supported by an armature structure that is attached to the opposite sides of the globe at the wheel axis. These attachments having ring hearings connecting the armature and to the globe wheel dome ends.

The ring bearings are designed to allow an electromagnet to be located at a center point inside the ring bearings, wherein the electromagnet will power the two inner wheels at all phases of its rotational cycle and thereby enabling the outer wheel to rotate and create a pivoting point on the inner wheels that is oriented 90 degrees off said inner wheels axis. The armature has three additional electromagnets positioned over the outer globe wheels center rim, positioned at approximately 10:00 (ten o'clock, 12:00 (twelve o'clock) and 2:00 (two o'clock). The armature is attached to allow the wheel works or wheel assemblies to rotate.

The device is engineered to operate at high rpms which require less energy to maintain the rpm, much the same as a flywheel acts when it reaches a desired momentum. When operating at high rotational speeds a geometric arrangement of preferably three or more wheel works devices in a drive system is preferred, whereby all three devices can control the vehicle movement by directing vector forces inwards (canceling each other's directional forces) or outwards in a coordinated directional manner, adjusting for vehicle weight and/or desired elevation and adjusting for vehicle maneuvering needs. The geometric arrangement enables a controlled omni-directional drive system and a manner to provide for slow to high speed movement and maneuvering of a vehicle powered by the drive according to the invention.

It is further contemplated that to mercury could be employed as a weight electromagnetic field characteristics at high rpm and the metal could reduce gyro forces and or gravitational effects on said wheel works. Its weight could enhance the flywheel effect and/or be used in said the weighted areas of the wheels. The device being totally enclosed by a spherical means, light weight, shock resistant, structurally strong ridged material like that of Lexan®, furthermore enabled to seal for the containment of a vacuum and or any other gas to reduce turbulence and friction on the said wheel works internal moving parts.

While in embodiments described herein use two inner wheels and one outer wheel, it is contemplated that other combinations of wheels may also be used advantageously with the invention.

### BRIEF DESCRIPTION OF THE DRAWINGS

FIG. 1 is an isometric front view in elevation of a first embodiment of a drive element of the invention.

FIG. 2 is a top view depicting the arrangement of three drive elements on a triangular vehicle wherein the force vectors are all directed to a central point.

FIG. 3 is a top view depicting the arrangement of three drive elements on a triangular vehicle and further depicting directional force vectors in the same direction.

FIG. 4 is a top view depicting the arrangement of three drive elements on a circular vehicle depicting force vectors directed to a central axis point.

FIG. 5 is a top view depicting a further arrangement of drive elements and further depicts directional force vectors.

FIG. 6 is a side plan view of the wheel assembly depicting both the inner and outer wheels.

FIG. 7 is a side fractional view of the semi-spherical dome with a window to allow inspection of a portion of the inner wheels 400 and 500 contained therein.

FIG. 8 is another front perspective view of the wheel works according to a first embodiment of the invention.

FIG. 8A is a side view of the wheel works of the invention schematically depicting the inner two wheels at four positions as they rotate around axis 810.

FIG. 9 depicts an illustration of the rotation the inner and outer wheels from a right side view at tour positions in a rotational cycle and that includes positions 9a, 9b, 9c and 9d.

FIG. 10 depicts an illustration of the rotation the inner and outer wheels from a left side view at four positions in a rotational cycle and that includes positions 10a, 10b, 10c and 10d.

FIG. 11 depicts an illustration of the rotation the inner and outer wheels from a top view at four positions in a rotational cycle and that includes positions 11a, 11b, 11c and 11d.

FIG. 12 depicts an illustration of the rotation the inner and outer wheels from a bottom view at four positions in a rotational cycle and that includes positions 12a, 12b, 12c and 12d.

FIG. 13 depicts an illustration of the rotation the inner and outer wheels from a side view at nine positions in a rotational cycle wherein the first and ninth position are the same.

FIG. 14 depicts a side view of an alternative embodiment of the inner wheel that includes a dynamic weight system wherein the wheel is in a balanced condition.

FIG. 14 A depicts a side view of an alternative embodiment of the inner wheel that includes a dynamic weight system wherein the wheel is in a balanced condition that includes directional arrows to identify the direction of travel by weights.

FIG. 15 is a side view of the alternative inner wheel depicted in FIG. 14 further reflecting the two movable weights at different respective positions than that depicted in FIG. 14 and closer to a fixed weight.

FIG. 16 is a side view of the alternative inner wheel depicted in FIG. 14 and depicts two moveable weights at yet further different positions.

FIG. 17 is a side view of the alternative inner wheel depicted in FIG. 14 further reflecting the two moveable weights at positions in close proximity with a fixed weight.

FIG. 18A depicts a front view of the inner wheels contained with the spherical structure that includes a gear box to maintain the rotation of the inner wheels at a fixed ratio.

FIG. 18B depicts a front view of the inner wheels depicted in FIG. 18 that have been rotated 90

FIG. 19A depicts a front view of an alternative embodiment of the invention that uses opposite rotating arms.

FIG. 19B depicts a side view of the alternative embodiment depleted in 19A wherein the arms are turned 90 degrees at a second position of a cycle.

FIG. 19C depicts a further position, of the embodiment of the invention depleted in 19A as it rotates at a third position of a cycle within the octet spherical wheel.

FIG. 19D depict a further position of the embodiment of the invention depicted in of 19A as it rotates within the outer spherical wheel at a forth and home position of the cycle.

FIG. 20A is a schematic front view of an embodiment of an embodiment of the invention wherein the weights of the inner each of the inner wheel are at opposite positions.

FIG. 20B is a schematic side view of the embodiment of FIG. 20A of the device wherein the weights of the inner each of the inner wheel are at opposite positions.

FIG. 20C is a front view of the embodiment of FIG. 20 in elevation showing a schematic illustration.

FIG. 21A is a front view of an embodiment of the invention depicted that further depicts a bearing for a spherical wheel.

FIG. 21B depicts a view in elevation of a ring bearing positioned on a support armature for the spherical wheel, along line 21B.

FIG. 21C depicts the embodiment depleted in FIG. 21A with the two inner wheels oriented parallel with the support surface.

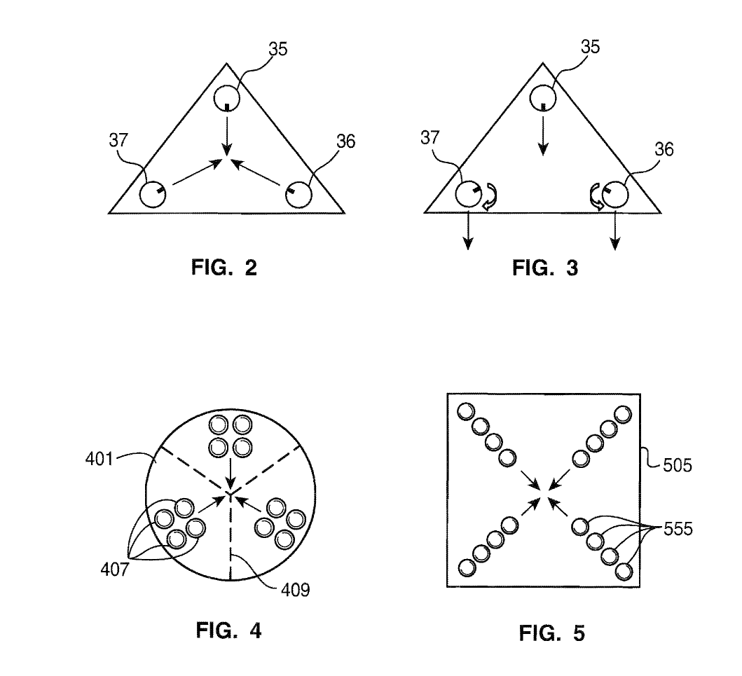

FIG. 2D depicts a top view of the gearing relationship of a gear and a surface of one of the inner wheels.

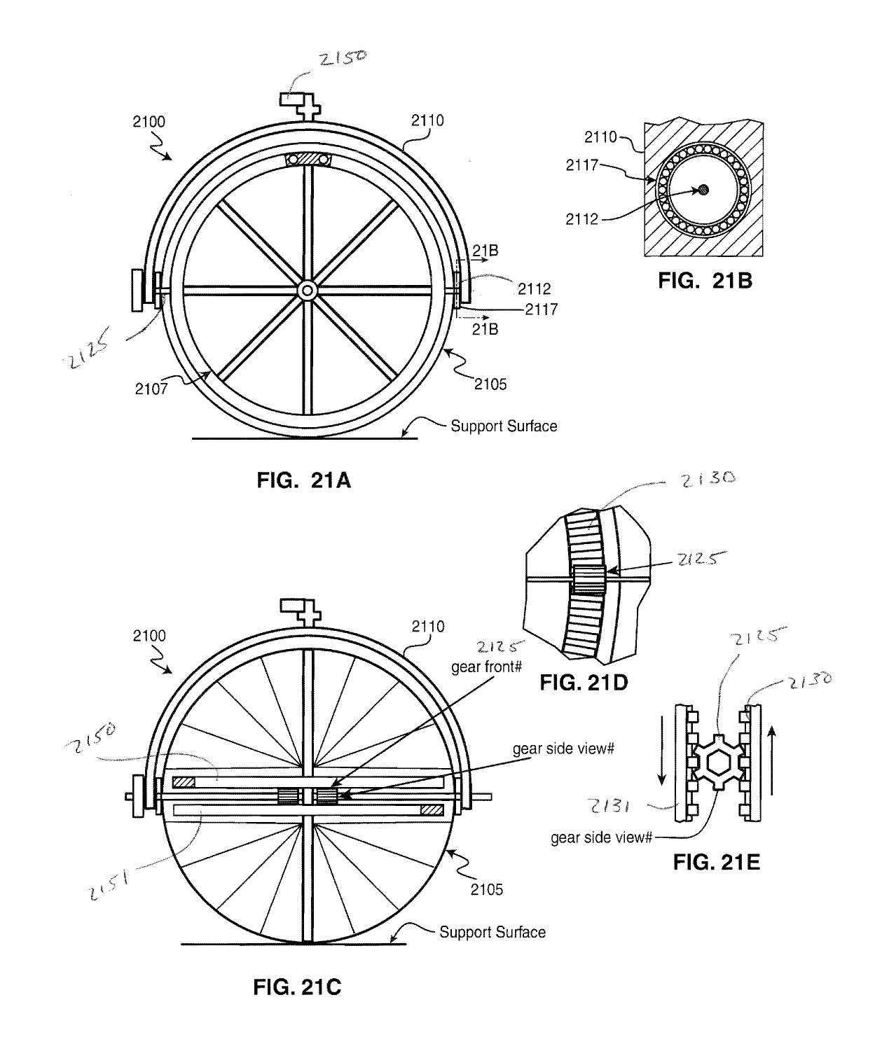

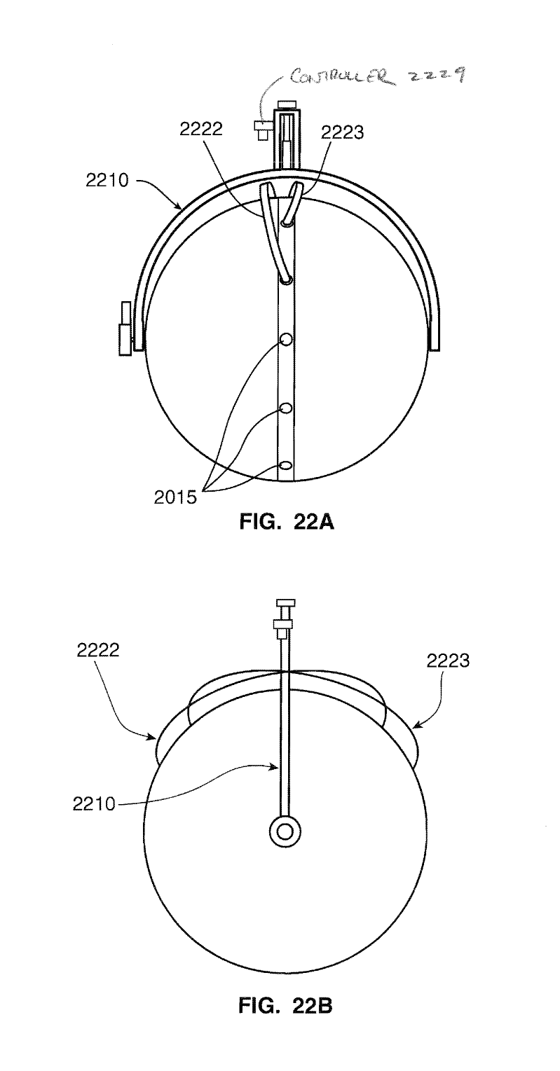

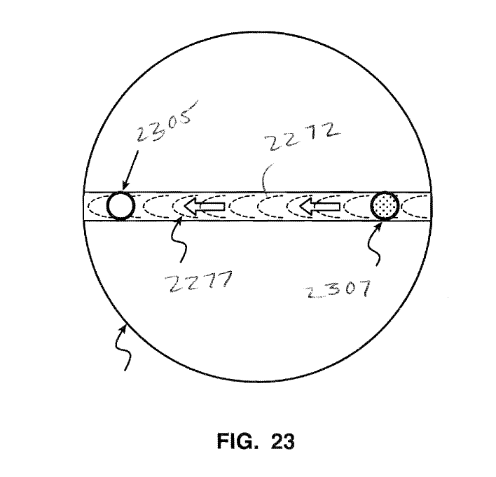

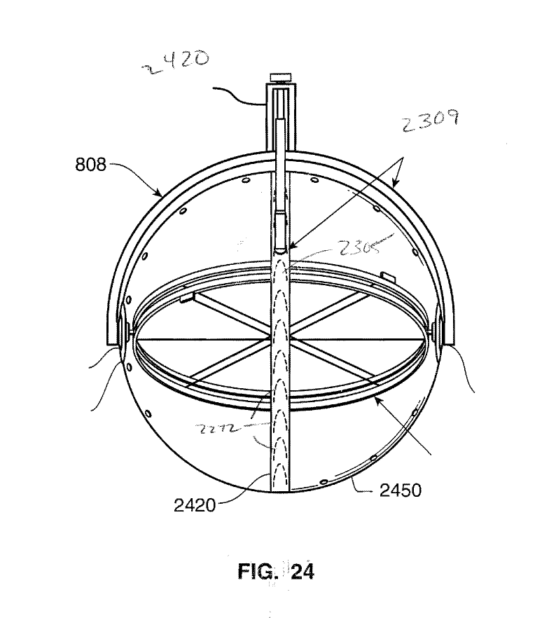

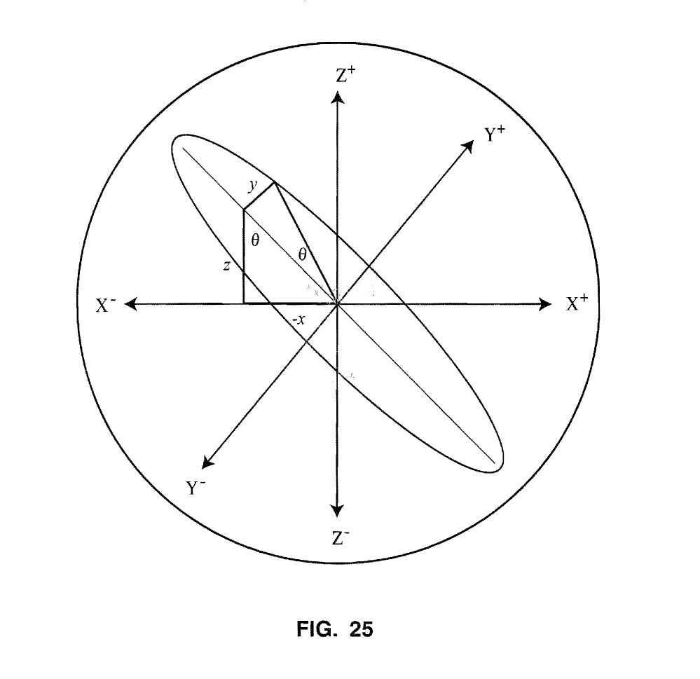

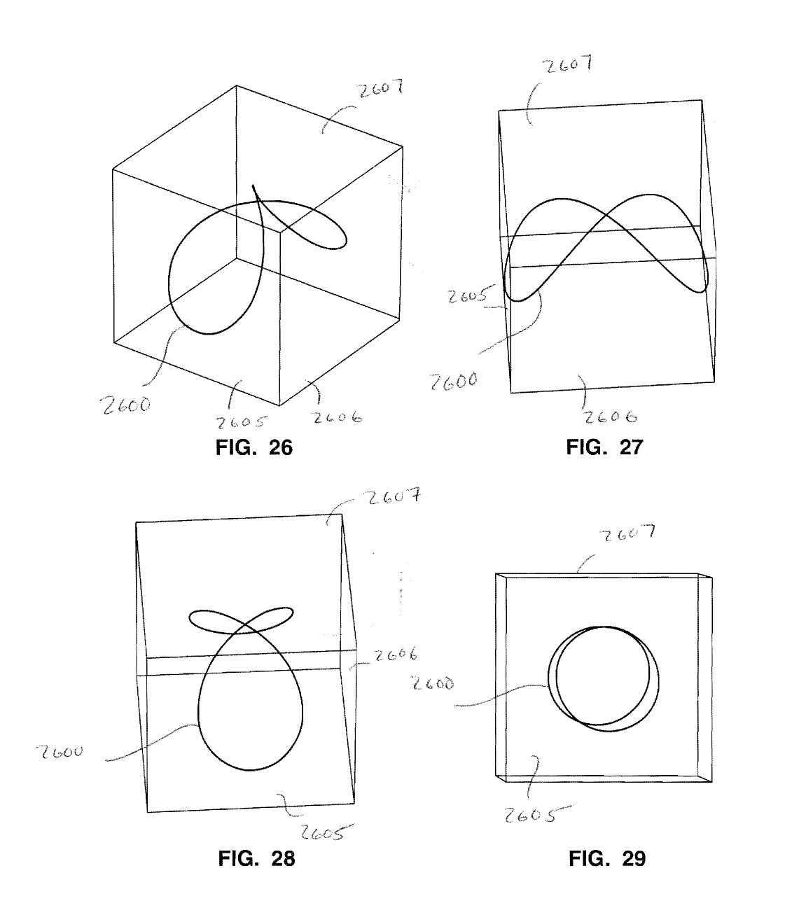

FIG. 21E depicts the 1:1 gear engagement between the two inner wheels.

FIG. 22A depicts a front view of an alternative embodiment of the device with an external magnetic drive arrangement.

FIG. 22B depicts a schematic side view of embodiment of the invention depicted in FIG. 22B.

FIG. 23 is a top front view of an alternative spherical wheel embodiment that uses an external thrust propulsion system to rotate the globe-wheel.

FIG. 24 is a rear plan view of the spherical wheel depleted in FIG. 23 that includes the support armature.

FIG. 25 is a schematic view of the position of a weight on the clockwise rotating inner wheel after a rotation of θ degrees as used in the first embodiment of the invention.

FIG. 26 is a first schematic isometric view of the orbit of the weighted section created by the rotation of the wheels from a first view that includes the top, a sides and an end of the three dimensional space in which the orbit is illustrated.

FIG. 27 is a second schematic isometric view of the orbit of the weighted section created by the rotation of the wheels from a side and top perspective.

FIG. 28 is a third schematic isometric view of the orbit of the weighted section created by the rotation of the wheels from an end and top perspective.

FIG. 29 is a fourth schematic isometric view of the orbit of the weighted section created by the rotation of the wheels from an end perspective.

### DETAILED DESCRIPTION

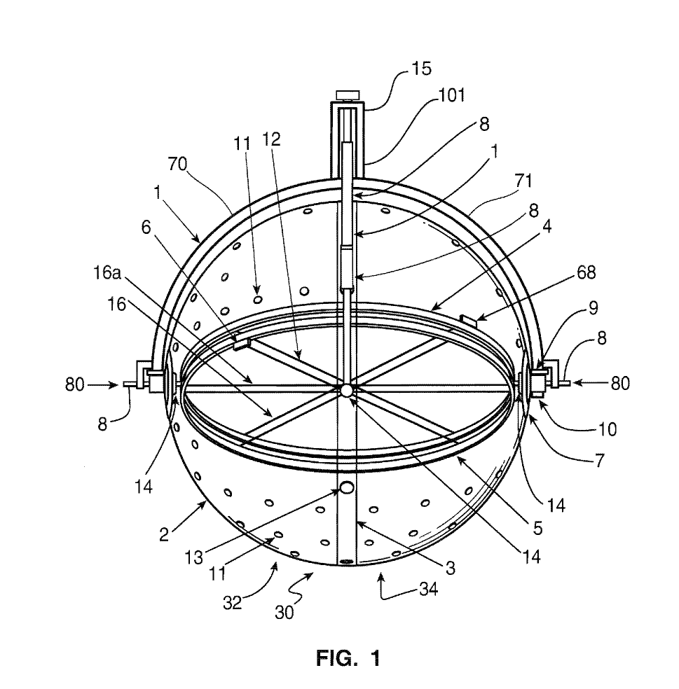

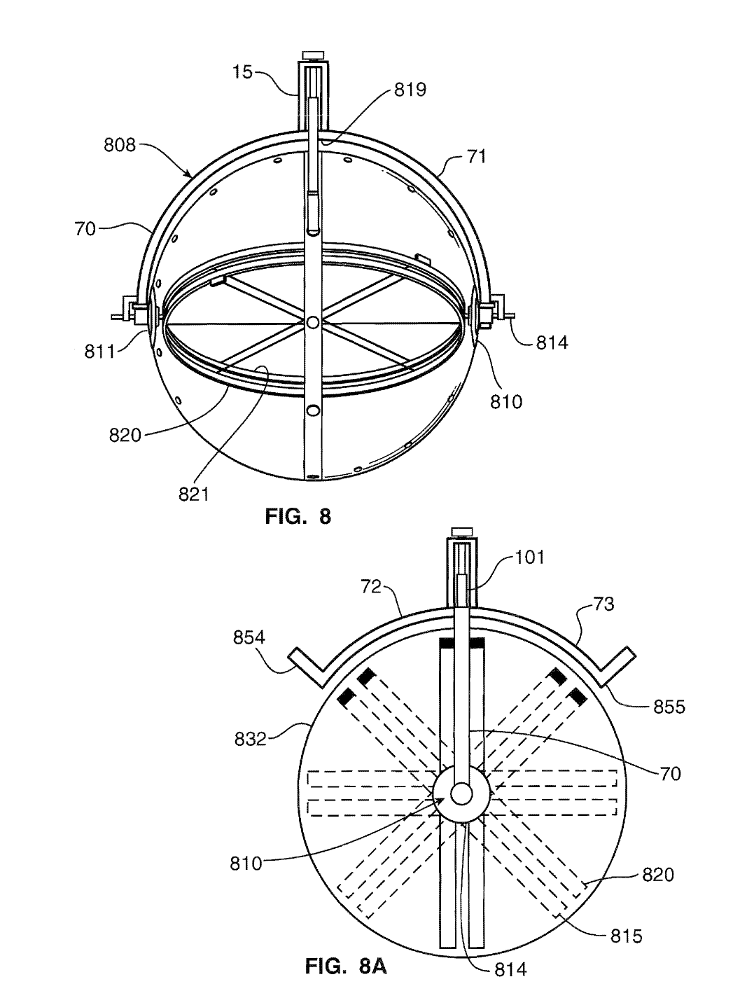

Now referring to FIG. 1, an armature support structure 1 is provided for holding the wheel assembly or drive element, generally designated by the reference numeral 30 according to the invention. The armature includes two opposite arms 70 and 71 that extend down and engage and axel 80 which extends on opposite sides of wheel assembly that includes wheel 4 and wheel 5. As seen in FIG. 8A the armature 1 also includes arms 72 and 73 that are oriented in a direction 90 degrees from the arms 70 and 71.

A globe structural 2 is comprises and of two semispherical parts 32 and 34 which extend from, an outer wheel structure 3. The dome parts are attached to both the left and right sides of an outer rim of outer wheel 3 and defining a spherical or “globe wheel” that encloses the inner wheels 4 and 5. The globe is preferably comprised of a shock resistant, strong, lightweight material like Lexan. The device further includes globe structure spokes 12 for stabilizing stress on inner wheels axis support shaft by omni directional secured wire spokes 12 and further serve to transfer vector forces generated by the inner wheels 4 and 5 to the outer globe location 11 and consequently to the wheel armature support 15.

Referring to FIG. 1, positioned within outer wheel 3 is two inner wheels 4 and 5 include a rim having a plurality of rare earth magnetic rod spokes 16 and 16a. The rim is comprised of a non-magnetic material. Attached on the rims 4 and 5 are weights 6 and 68 respectfully that do not have a counter-balance element. The rim area of a first inner wheel 5, from which extends a plurality of rare earth magnetic rod spokes, a rim of non magnetic material, furthermore said rim having a weight 6. The wheels do not have a counterbalance or counterweight, and further because the rim is placed at the moment of orbit, when rotated a force vector is created.

Structural axis support member 7 provides in attachment point for the outer globe wheel to be received on the armature. The support member allows the wheels to be rotated in 360 degrees. An electromagnetic rod 8 serves as the axis extended from the support member and is attached by engagement with ring bearing 10.

Washer head element 11 and similar elements are distributed over the globe and are adapted to receive and hold wheel spokes. In preferred embodiments the spokes are provide with a base sandwich with a resilient material to diminish and or disperses stress forces and vibrations between the spokes and the outer rim and maintain a seal within globe. Outer wheels spokes 12 are provided for the attachment of the inner wheels support shaft to the outer-globed wheel at multiple stress angles.

Rare earth magnetic rod spokes 13 connect the inner shaft of the outer wheel 3 with the rim and are used in connection with the electro-magnetic population system that turns the outer globe wheel 3. (See FIG. 8A)

A magnetic switch 14 is activated by the magnetic spokes 13 as they pass by the location of the switch. In the alternative, a magnetic sensor is provided that senses the magnetic spokes 13 and, in response, sends a signal to a processor that in turn switches the current in the driving electromagnetic element 101 that drives the outer wheel. Referring to FIG. 8a, in embodiments a plurality of electromagnetic elements such as 854 and 855 are provided to drive the outer wheel. In embodiments, the outer wheel includes at least 4 rod spokes and is placed for timing for the activation of the electromagnetic to reverse polarity at the time the rod spoke magnet 13 is in directly alignment with a driving electromagnet. The armature 808 is supported by post 15 that allows the wheel element or wheel works to freely rotate in either a counter-clockwise or clock-wise direction. In embodiments, the orientation of the wheel works is also controlled by a motor (not shown).

The assembly also includes rare earth magnetic rod spokes 16 and 16a that extend from the rim to the central shaft and support the inner wheels. These spokes further serve as part of the electro-magnetic motor system that turns the inner wheels 4 and 5.

FIG. 2 shows a top schematic view of a craft or vehicle having three wheel work devices rotating at high rpm, in a triangular arrangement, whereby in this illustration the wheel work devices 35, 36, and 37 the force vectors are all directed to the center of the triangle, canceling out the vector forces in lateral directions.

FIG. 3 depicts a top schematic view of the craft depicted in an alternative arrangement wherein the force vector from the wheel assemblies is directed in the same direction. Everything is the same as that described in FIG. 2 but in this illustration, two of the wheel works are rotated thereby directing the forces of all three wheel works to be engaged outward and in a specific direction.

FIG. 4 depicts a top schematic view of a triangular arrangement on a circular craft 401 having multiple wheel works 407 that are arranged to evenly balance a load on the craft. As depleted in FIG. 4 there are pluralities of wheel works on each side of the dividing lines 409 of triangles that define three points. This illustration is for a wheel work arrangement for crafts carrying heavy weight.

FIG. 5 is a top schematic view of a square craft 505 using a four point or square wheel works 555 arrangements, wherein the placement follows the dividing line from corners to center of square. Here again, this arrangement is adapted for carrying heavy weight.

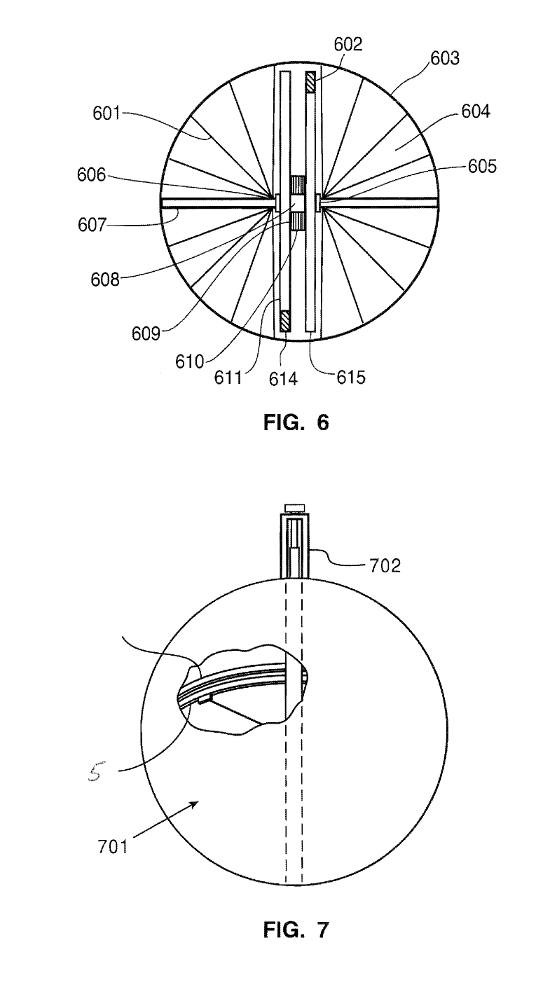

FIG. 6 in sectional view of a wheel work having a portion of the outer shell or dome removed to real a portion of the inner wheels, support shaft, geared bearings and outer wheels inner magnetic rod spokes. Referred now to FIG. 6, a powerful magnetic rod spokes 601 is depicted extended from the outer wheels interior rim to a location near the inner wheel's central shaft. A second rod spoke 7 also extends from the central axis of the to the outer wheel's rim. The inner wheel 602 and 614 are positioned within the outer wheel rim 603 to permit rotation. The transparent dome structure 604, preferably comprised of Lexan, extends from rim and below the components that are shown. Supporting the inner wheels to provide for ration is inner wheel bearing 605.

As illustrated in FIG. 6, a support means 606 is provided from which a plurality of rod spokes extend from near the center of the wheel to outer rim of the exterior wheel. Main shaft 607 supports the inner wheels and it is attached to opposite sides of the rim of the outer wheel. Shaft 607 likes the other shafts such as 601 also serves as a powerful magnetic rod.

Support means 608 contains gear bearings (nor shown) on which the inner wheels 614 and 615 rotate. Bearings 605 and 606 are also positioned on the external sides of the inner wheels. Gear 609 maintains the position of the inner wheels in a fixed position with respect to one another. Roller hearing 610 maintains the wheel apart from one another. 611 (also referred to as 614) is one of the inner wheels.

As best seen in FIG. 7, a front view of the said wheel works is enclosed by a spherical means 701, like that of Lexan, furthermore enabled to seal and contain a vacuum and or any other gas to reduce turbulence and friction on internal moving parts. Armature support 702 is provided to support the wheel works contained within the globe 701.

Now referring to FIG. 8, a front plan, view is depicted that includes the armature 808, armature and support 815. Electromagnet 811 powers the inner wheels 820 and 821 and electromagnet 819 powers outer wheel 830. FIG. 8A is a side view of the device depleted in FIG. 8 and includes electromagnetic driver 101 positioned in the armature support 15. As shown in FIG. 83 the armature has arms 73 and 72 that extend along an arc over the outer wheel 830 and 70 and 71 which hold the axle 814 for the inner wheels 820 and 821.

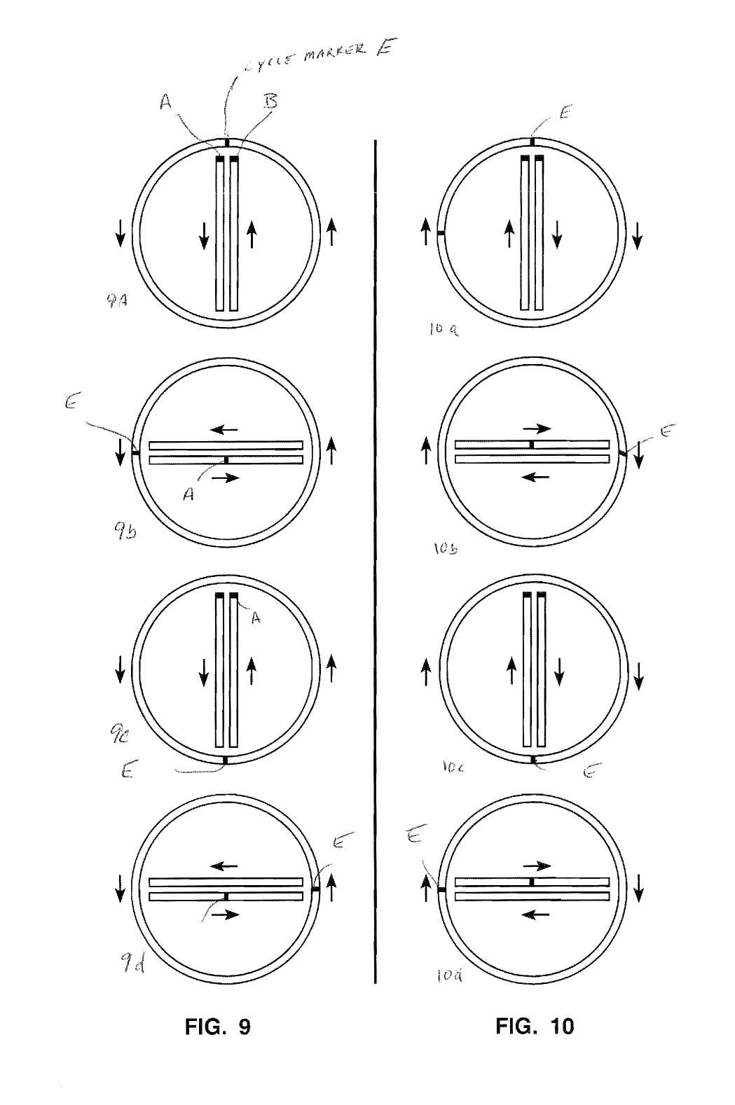

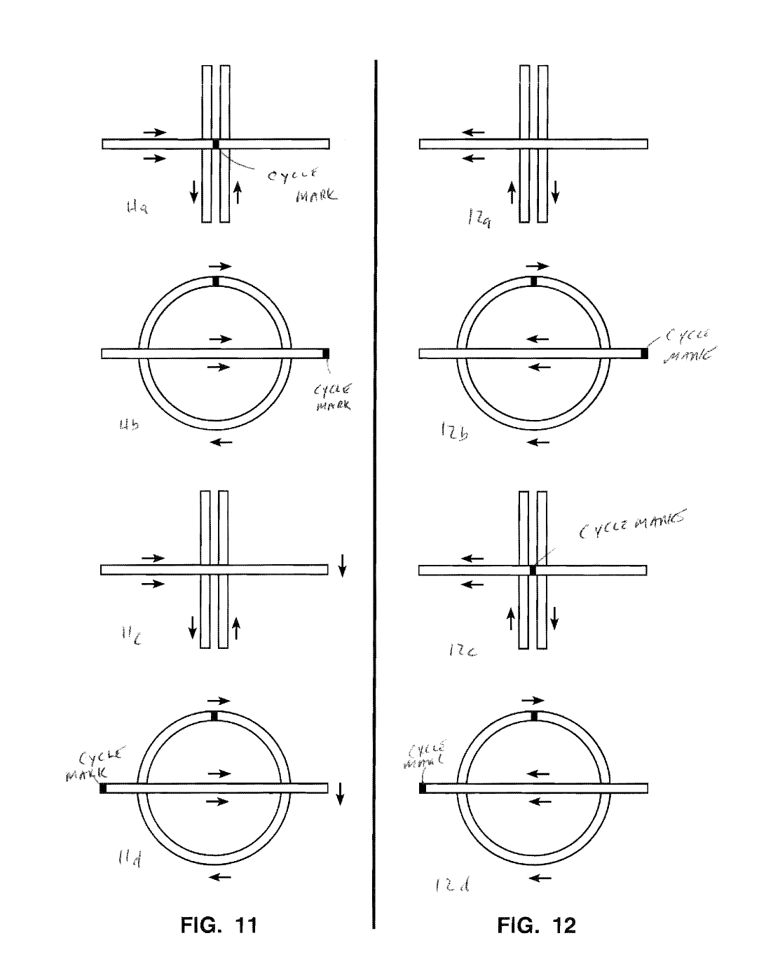

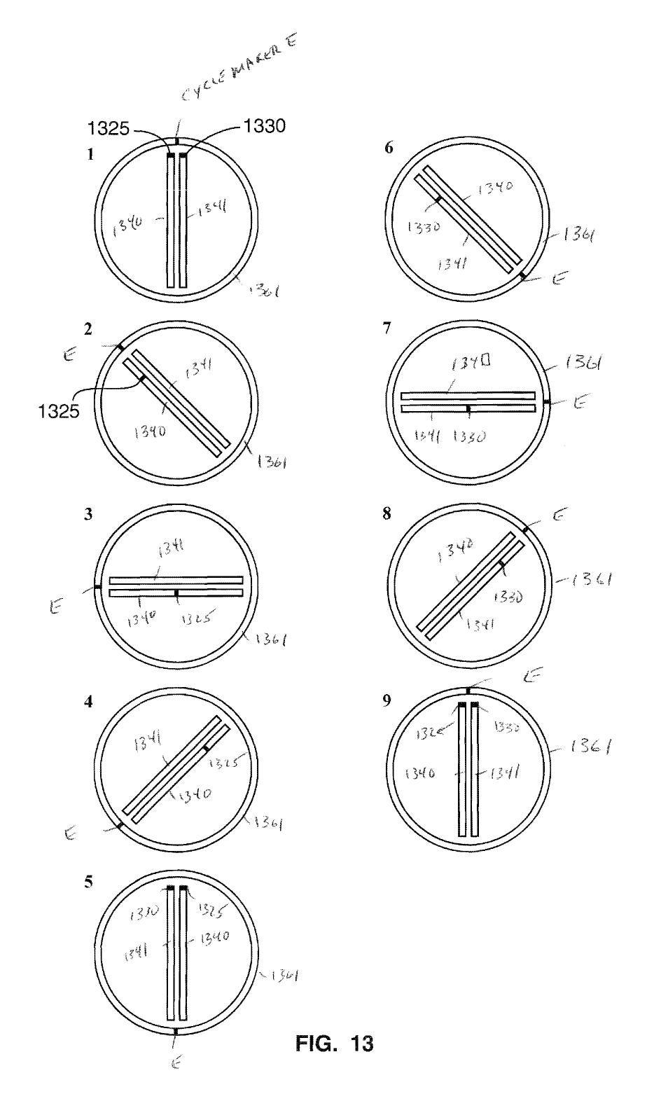

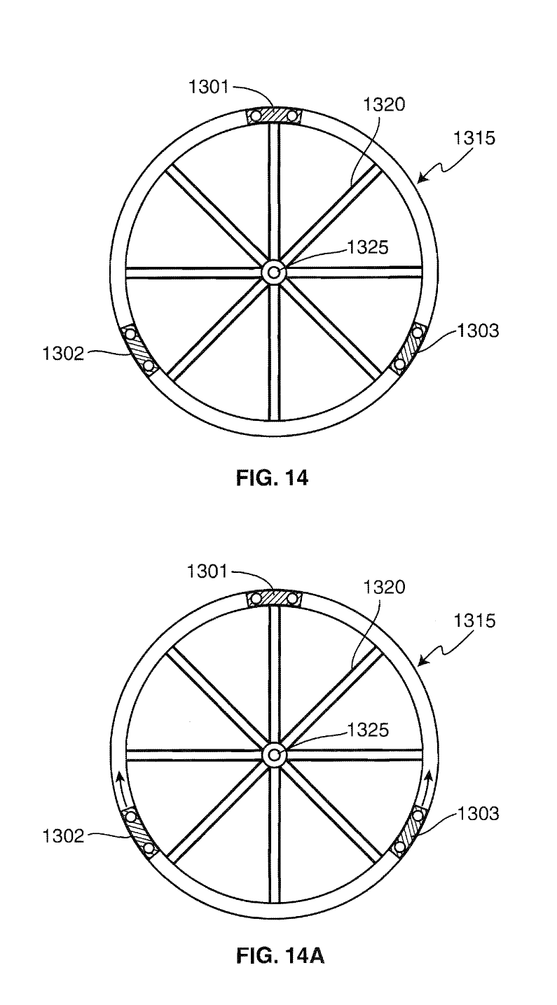

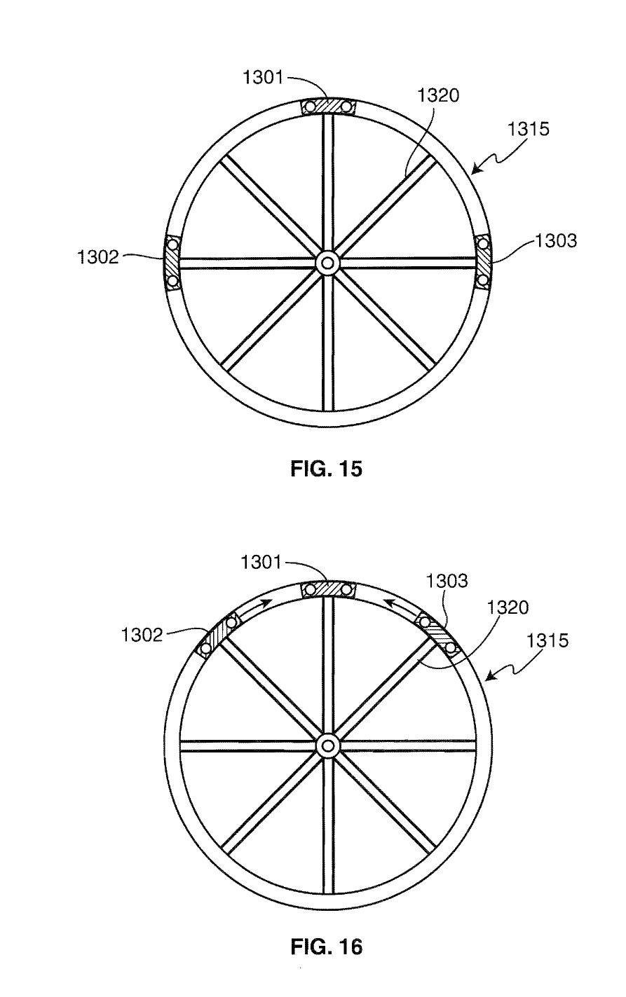

FIG. 9 is a schematic view depicting the respective rotation by the inner and outer wheels. The inner wheels rotate in opposite directions. FIG. 10 is a schematic illustration of rotation of the respective wheels from the left side; FIG. 11 is a schematic depiction of the rotation of the inner and outer wheels from a top view and FIG. 12 depicts a bottom view. FIG. 13 depicts yet another from the right side (like FIG. 9) depicting more positions occupied by the inner wheels as they rotate. FIG. 13 illustrates the movement of weights 1325 and 1330 on the two respective inner wheels 1340 and 1341 as they rotate within the outer wheel 1361 from position 1 to position 9.

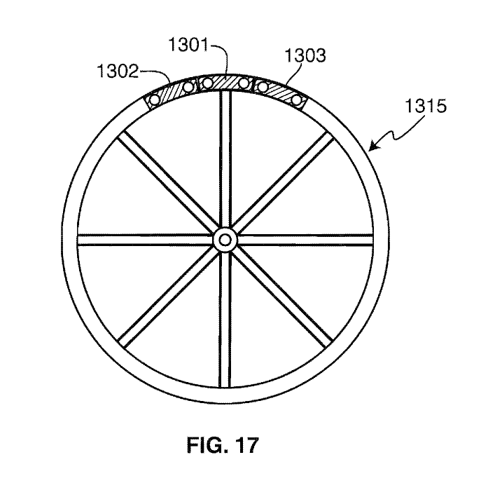

Now referring to FIGS. 13-17, in an alternative embodiment of the invention, the weights in the inners opposite wheels may be moved around the circumference of the rims and can therefore move from a balanced equidistant position to varying and different degrees of unbalance positions. The weights may be driven using a servo electric motor (not shown) or by other known techniques known the art and the small motor (not shown) is provide with and serves as further weight in structures 1302 and 1303. In embodiments, the motor includes a wireless activated controller which can be activated in response to signals or can be activated at predetermined time intervals. The weights structure 1002 and 1302 are provided in a track having teeth or threads (not shown) and the motor has a gear attached thereto with opposite teeth or threads that is driven within the track in the rims of the inner wheels. Accordingly, as depleted in FIG. 13 the weights 1301 1302 and 1303 are in a balanced position within a track provided in wheel 1315 and therefore equidistance from one another and each of the weights having equal mass. FIG. 14 depicts the direction that the eights 1302 and 1303 may travel which will increase the three as the balance on the wheel is diminished. FIG. 15 depicts weights 1303 and 1303 at opposite locations on inner wheel 1315. FIG. 16 depicts a further position of weights 1302 and 1303 with respect to weight 1301. When the weights are in these locations, the forces are yet further increased when compared to the position of the weights as illustrated in FIG. 15. In FIG 11 the weights 1302, 1301 and 1303 are all directly adjacent to one another and thereby in this orientation the wheel may generate the largest force when inner wheel 1315 is rotated.

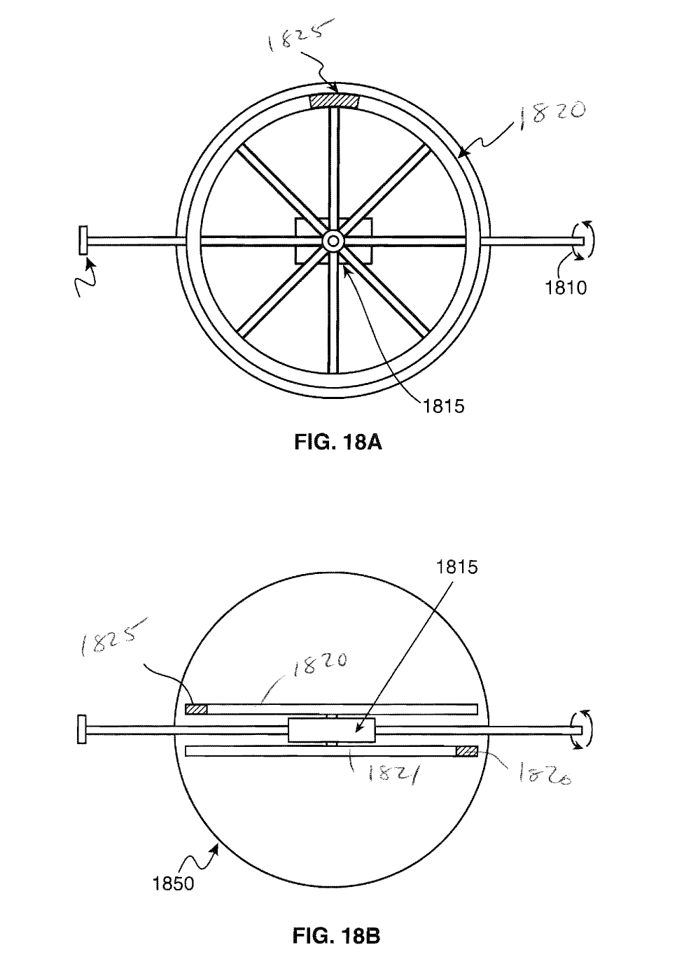

FIGS. 18A and 18B depicts a further embodiment that includes shaft 1810 for the transmission of power from a location on the outer housing. A three-way gear is also schematically Illustrated that keeps the rotation of the inner wheels at fixed speed and locations with respect to each other and with counter rotating output shafts. The gearing is at a 1:1 ration and the wheels turn in opposite directions. As discussed above, the inner wheels are provided within a domed wheel structure 1850. The gear may be powered by attaching a shaft to the shaft gears housing and rotating the housing thereby powering the counter-rotating shafts. Rotation of axel 1810 is transferred by the gearbox 1815 to turn the inner wheels 1820 and 1821 within the outer wheel.

In connection with the fixed weight embodiments, rotation of the wheels creates a “figure eight” orbit tor the weights or moment of mass of the weights as they travel about the inner and outer wheel. This orbital motion results from the rotation of weighted outer rotating wheel and two weighted inner rotating wheels whose rotations are perpendicular to the rotation of the outer wheel and opposite each other. As described in above, two weights on the inner wheels both begin in the top center position. The outer wheel rotates counter-clockwise θ degrees, while the inner wheels rotate clockwise and counterclockwise, respectively, by that same angle measure.

Referring now to FIG. 25 the position of the weight on the clockwise inner wheel after a rotation of θ degrees for inner wheels and outer wheel. Table 1 gives the x, y, and z positions of each weight for each 45° increment of the first cycle.

Position Coordinates (x, y, z)
A Weight

| θ | X | Y | z |
|---|---|---|---|
| 0° | 0 | 0 | 1 |
| 45° | −½ | $\frac{\sqrt{2}}{2}$ | ½ |
| 90° | 0 | 1 | 0 |
| 135° | ½ | $\frac{\sqrt{2}}{2}$ | ½ |
| 180° | 0 | 0 | 1 |
| 225° | −½ | $- \frac{\sqrt{2}}{2}$ | ½ |
| 270° | 0 | −1 | 0 |
| 315° | ½ | $- \frac{\sqrt{2}}{2}$ | ½ |
| 360° | 0 | 0 | 1 |

B Weight

| θ | X | y | z |
|---|---|---|---|
| 0° | 0 | 0 | 1 |
| 45° | −½ | $- \frac{\sqrt{2}}{2}$ | ½ |
| 90° | 0 | −1 | 0 |
| 135° | ½ | $- \frac{\sqrt{2}}{2}$ | ½ |
| 180° | 0 | 0 | 1 |
| 225° | −½ | $\frac{\sqrt{2}}{2}$ | ½ |
| 270° | 0 | 1 | 0 |
| 315° | ½ | $\frac{\sqrt{2}}{2}$ | ½ |
| 360° | 0 | 0 | 1 |

To derive the equations of motion for x, y and z position, as shown in FIG. 25, the following relationships amongst the x, y, and z coordinates of the weight are determined.

$$tan θ = \frac{- x}{z} = \frac{y}{\sqrt{{x}^{2} + {z}^{2}}}$$

$${x}^{2} + {y}^{2} + {z}^{2} = 1$$

Assuming the inner wheel radius equal to 1 unit, the following derivation yields parametric equations for the motion of the two weights.

x=−z·tan θy=\sqrt{x²+z²} tan θ

x²=z²·tan θy²=(x²+z²)tan² θ=z²(tan² θ+1)tan² θ=z²sec²θ·tan²θ

z² tan² θ+z²sec²θ·tan²θz²=1→z²(tan² θ+1+sec²θ·tan²θ)=1→z²(sec²θ+sec^{θ·tan}² θ)=1→z²sec²θ(1+tan² θ)=1→z²sec⁴θ=1→z²=cos⁴θ→z=cos² θ

By substitution of this expression for z, the expression for x and y can be calculated.

x=−z·tan θ=−cos² θtan θ=−sin θc cos θ

y=\sqrt{x²+z²} tan θ=\sqrt{sin² θ cos² θ+cos⁴ θ}·tan θ=\sqrt{cos² θ(sin² θ+cos² θ)}·tan θ=\sqrt{cos² θ(1)}·tan θ→y=cos θ tan θ=sin θ

Assuming an inner radius of 1 unit, we have the following parametric equations for position is terms of the angle of rotation θ.

x(θ)=−sin θ cos θ

y(θ)=sin θ

z(θ)=cos²θ

Given an arbitrary inner radius of r units, the equations are then:

x(θ)=−r sin θ cos θ

y(θ)=r sin θ

z(θ)=r cos²θ

Given an angular speed ω, whose units are angle measure divided by time, we can then use the substitution θ=ωt to rewrite the equations in terms of time t.

x(t)=−r sin(ωt)cos(ωt)

y(t)=r sin(ωt)

z(t)=r cos²(ωt)

If we furthermore specify ω to be measured in revelations per minute, t to be measured in seconds, and θ to be measured is radians, then we have

$$θ = \frac{2 π ω t}{60} = \frac{π ω t}{30} ,$$

$$x ( t ) = - r sin ( \frac{π ω t}{30} ) cos ( \frac{π ω t}{30} )$$

$$y ( t ) = r sin ( \frac{π ω t}{30} )$$

$$z ( t ) = r {cos}^{2} ( \frac{π ω t}{30} )$$

These equations are identical tor both masses, with the exception that the y position is opposite for the weight on the counterclockwise inner wheel. The path 2600 of motion of the weight vector is depicted in FIGS. 26, 27, 28 and 29 and referred to herein as a multidimensional FIG. 8. The view depicted in FIG. 26 includes the path 2600 fern a perspective wherein the top 2006, side 2606 and end 2605 are depicted. FIG. 27 depicts a view of the pads from the side 2606 and top 2607. FIG. 28 depicts a view from the end 2606 that also includes the top section. FIG. 29 depicts another view from the end 2605 of the path 2600.

By differentiating each of the position functions, it is possible to calculate the parametric

functions for each component of the linear velocity.

x′(θ)=sin² θ−cos² θ→(x′(θ))²=1−4 sin² θcos² θ

y′(θ)=cos θ→(y′(θ))²=cos² θ

z′(θ)=−2 cos θsin θ→(z′(θ))²=4 sin² θcos² θ

The formula for the linear velocity of the mass can then be derived in terms of the angle θ. It can then be seen that the linear velocity of each mass is greatest at the top and bottom of the cycle. At a given angle or time, the two weights of the inner wheels have equal velocities.

v(θ)={square root over ((x(θ))²+(y(θ))²+(z(θ))²)}

v(θ)=\sqrt{cos² θ+1}

Differentiating again yields the function for linear acceleration in terms of θ. The linear acceleration is zero at the top and bottom of the cycle.

$$a ( θ ) = \frac{- sin θ cos θ}{\sqrt{{cos}^{2} θ + 1}}$$

If we again specify ω to be measured in revolutions per minute, t to be measured in seconds, and θ to be measured in radians, giving

$$θ = \frac{2 π ω t}{60} = \frac{π ω t}{30} ,$$

we have the following functions for linear velocity and acceleration of the masses in terms of time t.

$$v ( t ) = \frac{π ω t}{30} \sqrt{{cos}^{2} ( \frac{π ω t}{30} ) + 1}$$

$$a ( t ) = \frac{- {r ( \frac{π ω t}{30} )}^{2} sin ( \frac{π ω t}{30} ) cos ( \frac{π ω t}{30} )}{\sqrt{{cos}^{2} ( \frac{π ω t}{30} ) + 1}}$$

The profile of the orbit recited above can be further altered by altering the

positioning of the weights on the respective wheels. For example, the wheel embodiments depicted in Figs have a dynamic weight system wherein the location of weights can move along the rim of the wheels. Contemplated alternative embodiments, such, as depleted in 19A-D, use rotating arms can also be configured to result in the orbit described above. Moreover, like the embodiment depicted in FIGS. 14-17 weight 1955 on arms 1955 can be designed to move axially on the arm to alter the profile of the orbit. In embodiment, the weight is made from a ferrous metal and is repelled by an opposite force that also serves to drive the wheels.

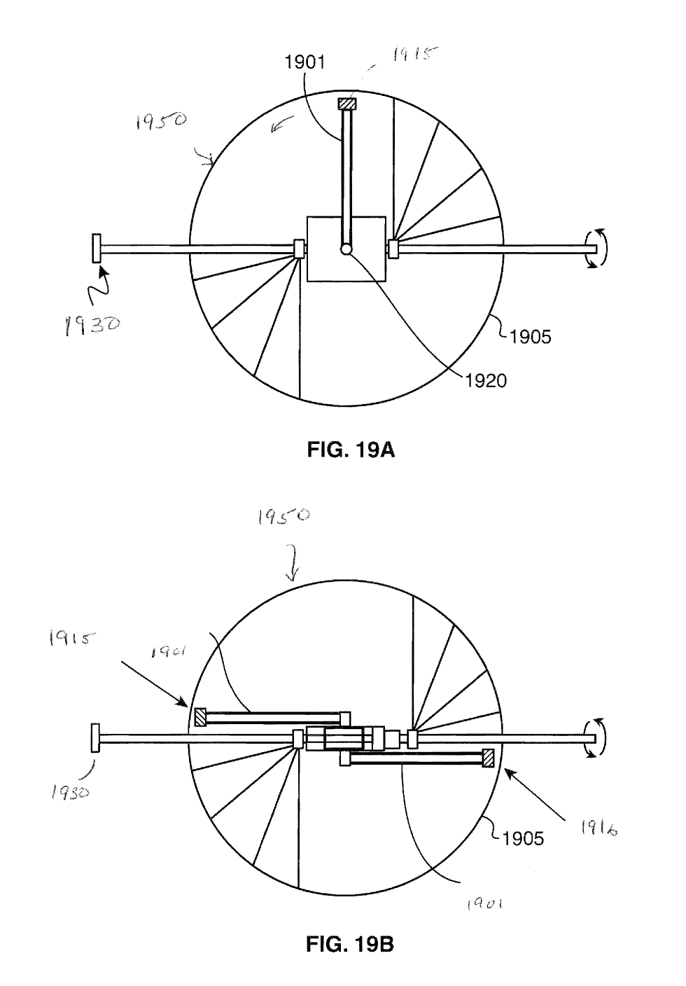

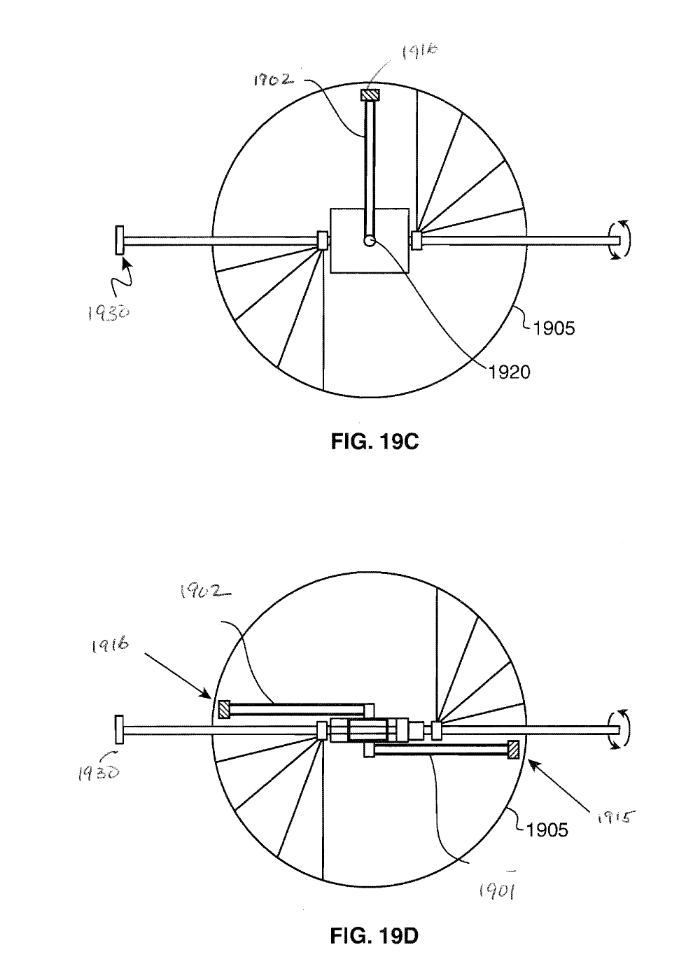

FIG. 19A depicts an alternative embodiment of the invention that has an outer wheel that is similar structure to the structure depicted in FIG. 1, but instead of oppositely rotating inner wheels, the force vector is generated using weighted arms 1902 and 1902 that extend from and spin In opposite directions around a central axis 1920. As shown in FIGS. 19A-D the point of attachment of the arms also rotates about axel 1930 with the globe wheel 1905. Weight 1915 is provided on the distal end of arm 1901 and weight 1916 is provided on arm 1902. The rotation illustrated in FIGS. 19A-19D creates the same bridged figure eight orbit as disclosed in other embodiments.

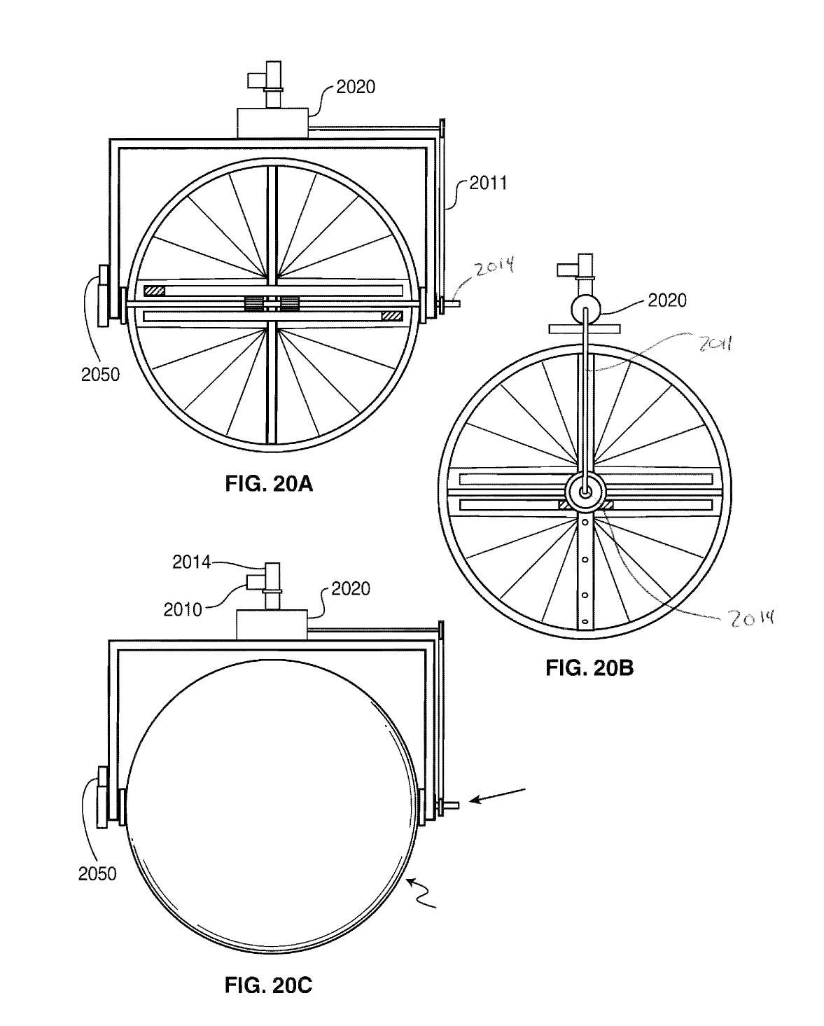

Now referring to FIG. 20, an external drive 2011 is depicted that powers the inner wheels by rotation of axis 2014 is depicted. e system depicted in FIG. 20 uses the same gear system that is illustrated in FIG. 18 and described herein. As best seen in FIG. 20C a horizontal rotate position motor 2010 is provided on the axis 2014 that can turn the wheel works on an axel 2014 to orient the direction of the globe wheel. A second power unit 2020 provides power to the inner wheel drive via drive chain 2011 (depleted schematically). In the embodiment depicted in FIG. 20A-C a vertical rotate position engine 2050 is provided on the support member.

FIG. 21A depicts a front view of an embodiment of the device that includes a ring hearing 2012 located on the inner surface 211 of support armature. As best seen in FIG. 21B the ring bearing surrounds the outer wheel axis point 2125 and engages the outer surface of dome wheel or globe 2105. The device depicted in FIG. 21 includes a controller 2150 that is schematically illustrated with the device. Referring now to FIG. 21C, this embodiment depicts a gearing version that uses two sprocket or bevel like gears located at both left and right sides of the inner wheels 2150 and 2151, one said gear is attached to the support armature, locked in position and the other said gear freely turns, said inner wheels having ring gear teeth in contact with said sprocket or bevel like gear, (see illustration B) furthermore as the outer wheel globe is powered to rotate the inners wheels will rotate in their counter-rotating directions, rotating around the said gears being an axis point. The gear is sized to maintain the 1/1 ratio with all three wheels. Furthermore depicted in FIG. 21B is a ring bearings that support the outer wheel globe, the said outer portion of the bearings casing is attached to the globe, while the inner portion of said bearings casing is attached to the said support armature 2112 that passes through the inner wheels and is received in opposite hearing 2125.

FIG. 22A shows an embodiment as illustrated in FIG. 21 wherein the rotation of outer wheel in this FIG. 22 is accomplished by the outer wheel having permanent magnet spokes as in FIG. 1. Electromagnets 2222 and 2223 have a north and south pole oriented opposite of the spoke array of the outer wheel. The electromagnets are activated by controller 2229 to switch the respective polarity of the magnets in response to the spokes passing. As best seen in 22B curved electro magnets 2222 and 2223 are attached to armature 2210, each electro magnet having a north pole and a south pole and are arranged so that when the alternating pole permanent magnetic spokes 2015 are in a position “top dead center” over said electromagnet on both sides of globe, a switch is activated causing a magnetic pulse of north polarity pushing said spokes away. Simultaneously said electromagnet's south pole sides being top dead center position over south pole said spikes, pushing the spoke away, following the end of the electromagnet's duty pulse, wherein the spoke magnet will pull the electro magnet's iron core. When the spoke reaches the top dead center of the electromagnetic element the current is reversed to a south pole polarity and the magnet will therefore respond to the south pole spoke. The pulse switch is then once again activated and the cycle repeats.

FIG. 23 and 24 shows a further embodiment wherein a turbine drive system 240 is provided to power the rotation of the outer wheel. This embodiment can use the inner wheel gear version as depleted in FIG. 21. In this embodiment the turbine means comprises an enclosed ring shape, having the outer turbine housing attached to the said support armature, the inner cupped ring parts 2272 being attached to said outer wheel, turning said wheel. Referring to FIG. 24 the turbine drive 2420 in connection with the air pressure or air file ports 2305 that and a nozzle 2309 to provide pressure thrust to the turbine drive that is encased in the outer spherical wheel 2450. Alternatively a fuel mixture may be provided to power a turbine combustion system.

Accordingly, disclosed herein are both electric powered wheels using magnetic drive propulsion as well as gear highbred versions, whereby inner wheels or “arms” have a locked gear means to the armature whereby inner wheels or “arms” rotate around said locked gear. In the embodiment depicted in FIG. 18, for example, only the outer wheel needs to be powered rotated to rotate the outer wheel and the inner wheels or “arms” (as depicted in FIGS. 19A-D). The inner wheels or “arms” are part of the gear assemble as further shown in FIGS. 21 and 22.

A turbine and gear embodiment of the invention is disclosed, whereby inner wheels

or “arms” have a looked gear means to the armature and whereby the inner wheels or “arms” rotate around said locked gear. In the embodiment described, only the outer wheel needs to be powered rotated to rotate the outer wheel and the inner wheels or “arms”. The inner wheels or “arms” are part of the gear assemble as depicted in FIGS. 21. and 23. A gear highbred version, whereby inner wheels or “arms” are connected to a three way counter rotating gear box, where the input shaft of the gear box is locked from turning and a power shaft, is attached to said box's housing or inner axis shall, said power shaft rotates said box or inner axis shaft, this version the inner wheels or “arms” are attached to gear output shafts, the outer wheel does not need to rotate and is a vacuum means and furthermore this said power shaft is powered by a separate power source such as a engine or motor means. See FIG. 18A, 18B, FIG. 19A and 19B and FIG. 20

In contemplated embodiments, the weights on all embodiments of wheelworks or devices may be provided with robotic or other powered means to alter the location of the weights in the rotating wheels. In yet further embodiments, the weights, which further comprise a fertile materials, are slidably attached to spokes in the wheels and the engagement of the opposite poles cause the magnetic to be repelled toward the central axis from the rim. As the wheel continues to rotate the weight will travel to the edge of the rim because of centrifugal force.

In embodiments, the movement of the weights may be remotely controlled using a wireless controller and servomotors wherein a wireless receiver associated with servomotor can receive a control signal and will cause the weight to move from a balanced to an unbalanced position. As discussed above, alternative systems may be provided that have permanent magnet weights that are mounted to slide on the a spoke shaft and can be externally manipulated by an external electromagnet pulse that will push the weights in a radial direction towards the center of the of the wheel. The electromagnetic force that causes the weights to move in a radial direction also serves to drive and rotate the wheels. The weights are then moved back to a distal position on the end of the spoke by centrifugal forces that are created by the rotation of the wheel. By altering the location of the weights a wide base bridged figure eight configuration may be altered to a narrow the base of a figure eight configuration thereby narrowing the force vector and increasing its magnitude.

It will be clear to one skilled in the art that the embodiments described above can be altered in many ways without departing from the scope of the invention. Accordingly, the scope of the invention should be determined by the following claims and their legal equivalents

I claim

1. An engine comprising a plurality of wheels, said wheels having weights contained therein and said weights putting the wheels in an unbalance condition, and said wheels further comprise a first outer wheel, said first outer wheel having an engine to rotate said outer wheel on a axis and at least one inner wheel, wherein said inner wheel has an engine to rotates said inner wheel within the outer wheel on an axis that is oriented 90 degrees from the axis of said outer wheel.

2. The engine recited in claim 1 further comprise a second inner wheel, said second wheel also provide with a weight putting the wheel in an unbalanced condition to in configure to rotate in an opposite direction as said first wheel.

3. The engine recited in claim 2 wherein said first and said second inner wheel are configured to rotate at the same speed.

4. The engine recited in claim 1 wherein said outer wheel further comprises a sphere.

5. The engine recited in claim 2 wherein said weight on said first inner wheel and second inner wheel have the same mass.

6. The engine recited in claim 1 wherein said weights of said inner and outer wheel define an orbit and said orbit is generally in the shape of a multidimensional bridged figure eight.

7. The engine recited in claim 1 wherein said outer wheel comprises sphere.

8. The engine recited in claim 7 wherein said sphere is devoid of air.

9. The engines recited in claim 1 further comprising a controller to control the speed of rotation of the first and second wheel and to power electromagnetic pulses to power said wheels.

10. The engine recited in claim 1 wherein said weights are movably attached along the rims of the wheel.

11. The engine recited in claim 9 wherein the weights are moved by a servo motor in response to a control signal.

12. The engine recited in claim 1 wherein the weights on said wheels are provided on spokes of said wheels.

13. The engine as recited in claim 1 wherein said outer wheel is powered by electromagnets.

14. The engine as recited in claim 1 wherein said outer wheel is powered by air pressure.

15. The engine as recited in claim 1 wherein the inner wheels are powered by an axel that translate motion from a motor positioned outside said outer wheel.

16. An engine comprising an outer shell and two inner rotating arms, said rotation arms positioned on an axle, means to rotate said arms and turn said axel wherein said inner arms rotate in opposite directions within said outer shell at the same velocity and said arms further rotate on said axle.

17. The engine recited in claims 16 wherein the rotation of said arms within said outer wheel and the rotation of the outer wheels create a force vector in an orbit and said orbit describes the direction of the vector at its maximum magnitude and said orbit is generally in the shape of bridged figure eight.

18. The engine recited in claim 16 wherein the said arms comprise weights on the end and said weights can slide down the arms in response to electromagnetic pulses at locations around said orbit the rotational orbit formed by the said arms and will side back to a distal position in response to centrifugal forces.

19. A method comprising using the engine recited in claim 1 to move a vehicle operating on a surface within a gravitational field.
